(19) United States
(12) Patent Application Publication
(10) Pub. No.: US 2011/0037312 A1
(43) Pub. Date: Feb. 17, 2011

(54) LEVERED CENTERPOINT SUSPENSION FOR A CATEPILLAR DRIVE

(76) Inventor: Eduard Arkadjevich Geraschenko, Moscow (RU)

Correspondence Address: Aleksandr Smushkovich, POB 140505, Brooklyn, NY, 11214, US

(21) Appl. No.: 12/736,604

(22) PCT Filed: Apr. 28, 2009
(86) PCT No.: PCT/RU2009/000204

§ 371 Date: Oct. 22, 2010

(30) Foreign Application Priority Data
Apr. 29, 2008 (RU) 2008116466

(51) Int. Cl. B62D 55/104

(52) U.S. Cl. 305/141

(57) ABSTRACT

A levered centerpoint suspension of a caterpillar drive comprises a pendulum arm, coupled to a frame via an elastic element, and an internal pivot pin geometrically coinciding with the rotational axis of a driving shaft of the drive. A balancing lever provided with track guiding wheels and/or track wheels and/or track slide guides is connected to the pendulum arm so that is capable of swinging thereon. The driving shaft with traction wheels rotates about the axis, and the pendulum arm's socket is swingable about the driving shaft. In an embodiment, the pendulum arm has a fork-like shape, whereas the balancing lever is H-shaped and comprises two longitudinal girders interconnected by means of a crossbar. The balancing lever is disposed between the pendulum arm blades and is connected to the pendulum arm, as to swing on a transverse axis. The suspension allows for improving the caterpillar drive's compactness.

### CROSS-REFERENCE TO RELATED APPLICATIONS

This application is a U.S. national stage application of a PCT application PCT/RU2009/000204 filed on 28 Apr. 2009, whose disclosure is incorporated herein in its entirety by reference, which PCT application claims priority of a Russian Federation application RU2008116466 filed on 29 Apr. 2008.

### FIELD OF THE INVENTION

The present invention relates to suspensions of caterpillar drives. The inventive levered centerpoint suspension of a caterpillar drive is intended, in essence, for the use primarily in light-weight cross-country caterpillar vehicles, including the cross-country vehicles with a sequential arrangement of caterpillar drives and with a second support means (ski, caterpillar).

### BACKGROUND OF THE INVENTION

In related art there is known a traditional levered centerpoint suspension, exemplarily described in a book “Lesnye Mashiny” (translated as “forest machines”, e.g. tractors, automobiles, diesel locomotives, etc.), which is a textbook for higher education institutions, Publishing House “Lesnaya Promyshlennost” (Russia) 1989, page 442. The mentioned related art suspension for a vehicle has a pendulum arm, connected to the vehicle's frame by means of elastic elements and by an axle of swinging, and a balancing lever provided with track guiding wheels and connected to the pendulum arm through the axle of swinging. The caterpillar drive includes drive (traction) and guiding wheels, which are mounted essentially on the frame. The aforementioned suspension has a drawback of insufficient compactness, because the pendulum arm and the balancing lever require a significant additional space.

The most closely related art device (herein also called a ‘prototype’) to the present invention is a suspension described in a Russian Federation Patent Application No 2006106493 “Suspension of caterpillar drive.”

The prototype describes a levered centerpoint suspension for a caterpillar drive of a vehicle, which suspension comprises a pendulum arm, coupled to the vehicle's frame via an elastic element and via an axle of swinging of the pendulum arm, wherein the axle coincides with the geometrically axis of rotation of the shaft of the sprocket wheels of the caterpillar drive, and a balancing lever provided with track guiding wheels and/or track wheels and/or track slide guides, which balancing lever is connected to the pendulum arm in such a way that it swings thereon.

The disadvantage of the prototype is the lack of elaboration of the design, geometry, and mutual positions of the suspension's components.

### BRIEF DESCRIPTION OF THE PRESENT INVENTION

On the other hand, the present invention provides for a compact caterpillar drive, with a stable geometry and kinematics of the inventive levered centerpoint suspension for use in lightweight, compact, cross-country vehicles (snowmobiles, motorcycles, ATVs, etc.) with elaborative design.

Additionally, such a suspension should ensure a relatively constant tension of the caterpillar track during operation of the suspension; it should have a simple and efficient mechanism for track tensioning, and a compensation mechanism for increasing the tension force of the track.

Therefore, in a preferred embodiment, the inventive levered centerpoint suspension for a vehicle is provided, wherein the vehicle includes: the levered centerpoint suspension itself, a frame, and a caterpillar drive; the caterpillar drive includes at least one traction wheel, at least one caterpillar track moved by the traction wheel, and a hollow driving shaft coupled with the traction wheel and having a driving shaft longitudinal rotational axis; wherein the levered centerpoint suspension comprises: an internal pivot pin fixedly mounted substantially to the frame and having an internal pin longitudinal rotational axis, the driving shaft rotatably embraces the internal pivot pin and is capable of rotation about the internal pivot pin; a pendulum arm supported by an elastic element mounted on the frame, the pendulum arm includes a socket having a socket longitudinal axis, the socket rotatably embraces the driving shaft, and is capable of swinging about the driving shaft, wherein the internal pin longitudinal rotational axis, the driving shaft longitudinal rotational axis, and the socket longitudinal axis essentially coincide; and a balancing lever rotatably mounted on and capable of swinging about an axle of swinging joined with the pendulum arm.

In another embodiment, the mentioned caterpillar track includes: an upper branch; and at least one upper support rolling wheel supporting the upper branch and mounted on the balancing lever in a region located upwards and forwards from the axle of swinging.

In another embodiment, the levered centerpoint suspension further comprises a means for adjusting a position of the axle of swinging in relation to a position of the pendulum arm.

In another embodiment, the pendulum arm has a fork-like shape defining two fork blades; the balancing lever has an H-like shape defining two longitudinal girders interconnected by means of a crossbar; the balancing lever is located partially between the fork blades.

In another embodiment, the axle for swinging extends within the crossbar, whereas the crossbar serves as a socket for swinging the balancing lever.

In another embodiment, the caterpillar track includes: an upper branch; and at least one upper support rolling wheel supporting the upper branch and mounted on the balancing lever in a region located upwards and forwards from the axle of swinging.

In another embodiment, the caterpillar drive further includes: a number of rear track guiding wheels connected by a rear shaft; the levered centerpoint suspension further comprises: a pair of bracket-earrings mounted on the rear ends of the girders, the bracket-earrings have an axis of swinging substantially perpendicular to the longitudinal plane of the vehicle, the bracket-earrings are interconnected through the rear shaft; and a means for limiting the rotation and the backward displacement of the rear track guiding wheels; the means for limiting joins the girders with the bracket-earrings; wherein, during the swinging, the rear shaft is capable of movement in the longitudinal direction with the track guiding wheels.

### BRIEF DESCRIPTION OF DRAWINGS

FIG. 1 schematically shows a general lateral view and a general plan view of the levered centerpoint suspension according to an embodiment of the present invention.

### DETAIL DESCRIPTION OF PREFERRED EMBODIMENTS OF THE INVENTION

While the invention may be susceptible to embodiment in different forms, there are described in detail herein, specific embodiments of the present invention, with the understanding that the present disclosure is to be considered an exemplification of the principles of the invention, and is not intended to limit the invention to that as exemplified herein.

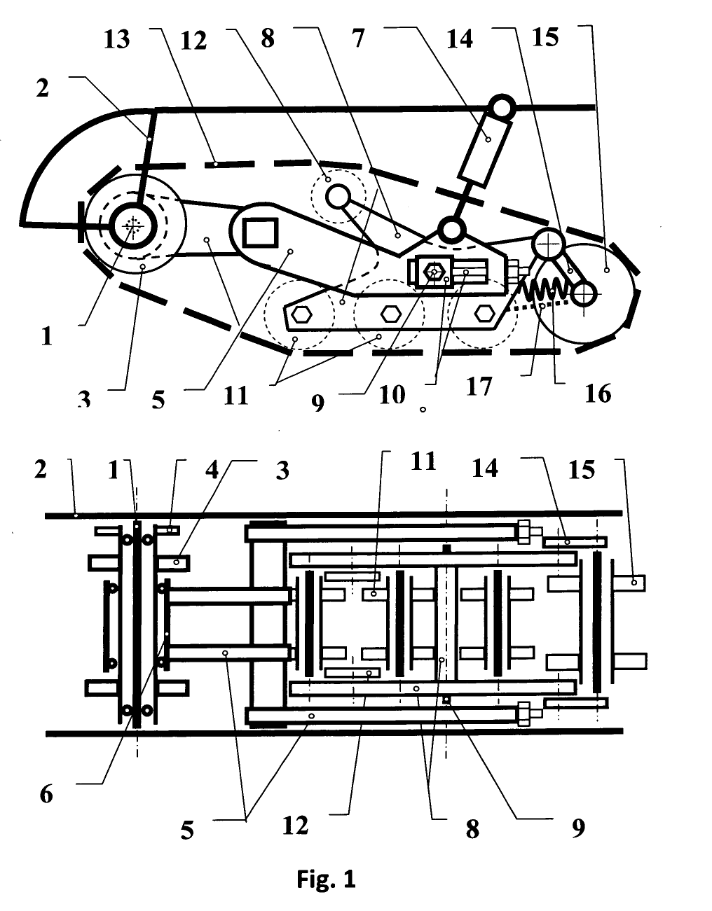

FIG. 1 shows a general view of a caterpillar drive for an all-terrain vehicle, according to a first preferred embodiment of the present invention. The vehicle includes a caterpillar track and a frame furnished with struts 2. The caterpillar drive includes: a caterpillar track with an upper branch 13 and a lower branch (not numbered); a number of track guiding wheels 15 (a pair of the guiding wheels 15 is illustrated on FIG. 1) mounted on a rear shaft rotatable around a rear axle; a pair of traction (driving) wheels 3 fixedly mounted on a driving shaft rotatable around an internal pivot pin 1, the internal pivot pin 1 is fixedly mounted to the struts 2; a sprocket wheel 4 fixedly mounted on the driving shaft, the sprocket wheel 4 is driven by a chain transmission that in turn is driven by the vehicle's engine.

The levered centerpoint suspension comprises: a fork-shaped pendulum arm 5 supported by an elastic compression element 7 mounted on the frame, the pendulum arm 5 includes a socket (bushing) 6 rotatably embracing the driving shaft essentially in its middle section, thereby providing the pendulum arm 5 with a capability of swinging about the driving shaft (i.e. the driving shaft serves a pivot axis for the socket 6); an H-shaped balancing lever 8 in the form of two longitudinal girders interconnected by means of a crossbar, the balancing lever 8 is connected to the fork of the pendulum arm 5, and the balancing lever 8 swings on the pendulum arm 5 through an axle 9, which is mounted inside the crossbar, which axle 9 serves as a bushing; the position of the axle 9 and the balancing lever 8, relative to the pendulum arm 5, can be adjusted in the longitudinal direction through a rectangular orifice cut out at the ends of the fork of the pendulum arm 5 and through a slide mechanism 10.

The caterpillar drive also includes: a plurality of track rolling wheels 11, each of the rolling wheels 11 is mounted on a corresponding shaft rotatable around an axle connecting the longitudinal girders (the rolling wheels can be alternatively substituted with sliding guides for the caterpillar track; upper support rolling wheels 12 movably supporting the upper branch 13, the rolling wheels 12 are mounted on the balancing lever 8 in a region located higher and forwards from the axle 9; bracket-earrings 14 mounted on the rear ends of the longitudinal girders of the balancing lever 8, the bracket-earrings 14 are capable of swinging around an axis substantially perpendicular to the plane of the balancing lever 8 and the caterpillar track, the brackets-earrings are connected by the rear shaft; during the swinging, the rear shaft is capable of moving in the longitudinal direction with the guiding wheels 15; elastic compression elements 16, mounted between the longitudinal girders of the balancing lever 8 and the bracket-earrings 14, the elastic compression elements 16 tend to turn the bracket-earrings 14, and move the rear shaft with the track guiding wheels 15 backwards; a flexible cable 17 connecting the longitudinal girders of the balancing lever 8 and the brackets-earrings 14, the cable 17, while being strained, limits the turn of the bracket-earrings 14 and the displacement of the track guiding wheels 15 backwards, and creates an initial preloading force of the elastic elements 16.

The claimed technical result is achieved by (see FIG. 1) that the levered centerpoint suspension of caterpillar drive comprising the pendulum arm 5, substantially associated with the frame struts 2 via the driving shaft, rotatable about the internal pivot pin 1 representing a geometric axis of swinging of the pendulum arm 5, and associated with the elastic element 7, wherein the axis of swinging of the pendulum arm geometrically coincides with the rotational axis of the driving shaft of the traction wheels 3 of the caterpillar drive, the balancing lever 8 with the axle 9 and the track wheels 11 (or track slide guides of the track), wherein the balancing lever 8 is connected to the pendulum arm 5 in such a way that it swings thereon; wherein the inventive suspension differs from the known levered centerpoint suspensions in that the axis of the internal pivot pin 1 is secured between two frame struts 2, the driving shaft rotates about the internal pivot pin 1, and the socket 6 of the pendulum arm 5 is put onto the middle part of the driving shaft as onto a pivot pin.

In another embodiment (not illustrated) of the present invention, the caterpillar drive includes: internal pivot pin fixedly mounted on two frame struts; a pendulum arm having a form of a U-shaped fork with two longitudinal blades and a transversely disposed socket joining the longitudinal blades, wherein the socket is externally and pivotally mounted on the internal pivot pin and capable of swinging thereon; and a driving shaft externally and rotatably mounted on the socket, substantially in a middle region thereof, and the vehicle's traction wheels are fixedly mounted on the driving shaft.

The next possible embodiment of the invention provides that in the region of joining with the balancing lever 8, the pendulum arm 5 has a fork-like shape, defining two fork blades, while the balancing lever 8 has an H-like shape, defining two longitudinal girders interconnected by means of a crossbar with a crossbar axis representing a transverse axis of the balancing lever; the balancing lever 8 is located partially within the ‘fork’ (i.e. between the fork's blades) of the pendulum arm, and connected to the pendulum arm 5 in such a way that the balancing lever 8 is capable of swinging about the transverse axis.

Further development of the invention may envisage an embodiment wherein the balancing lever 8 is connected to the pendulum lever 5 through the axis 9, passing within the balancing lever's crossbar, while the crossbar represents a socket for swinging of the balancing lever.

All this provides a compact, rigid, stable geometry and kinematics of the moving elements of the inventive levered centerpoint suspension during operation.

The following embodiments relate to furthering the improvement of performance of the above-described embodiments of the present invention.

It is possible to mount the upper support rolling wheels 12 of the upper branch 13 on the balancing lever 8 in a region located upwards and forwards from the axle of swinging 9. This helps to maintain a more stable tension of the track at the swinging of the balancing lever relatively the pendulum arm due to a variable geometrical configuration and a more stable maintaining of the track's length along a contour of the caterpillar drive.

It is also possible to regulate a position of the axle of swinging 9 and the connection point of the balancing lever 8 with the pendulum arm 5 in a longitudinal direction relative to positions of the pendulum arm and the driving shaft 3 by providing longitudinally cut holes at the ends of the fork's blades and a slide mechanism 10. This allows for easy and convenient adjusting the tension of the track due to a longitudinal displacement of the balancing lever 8 relative to the pendulum arm 5 and the driving shaft.

In other embodiments, it is also possible to mount the swinging bracket-earrings 14 on the rear ends of the girders of balancing lever 8, wherein the axis of swinging of the bracket-earrings 14 is substantially perpendicular to the longitudinal plane of the vehicle, and the bracket-earrings 14 are joined through the rear shaft of the rear track guiding wheels 15. The compression elastic elements 16 are mounted between the girders of balancing lever 8 and the bracket-earrings 14. The compression elastic elements 16 tend turning the bracket-earrings 14 and moving the track guiding wheels 15 backwards.

A flexible cable 17, which limits the magnitude of rotation and the backward movement of the track guiding wheels 15, can be mounted for joining the girders with the bracket-earrings 14. The cable 17 creates an initial compression force of the compression elastic elements 16. With increasing the track tension force over a certain amount, the track guiding wheels move forward, further compressing the compression elements 16, that dampens a sharp increase in the track tension force, thereby preventing the track from breaking.

1. A levered centerpoint suspension for a vehicle, said vehicle including:
said levered centerpoint suspension,
a frame, and
a caterpillar drive;
said caterpillar drive including at least one traction wheel, at least one caterpillar track moved by said at least one traction wheel, and a hollow driving shaft coupled with said at least one traction wheel and having a driving shaft longitudinal rotational axis;
wherein said levered centerpoint suspension comprising:
an internal pivot pin fixedly mounted substantially to said frame and having an internal pin longitudinal rotational axis, said driving shaft rotatably embraces said internal pivot pin and is capable of rotation about the internal pivot pin;
a pendulum arm supported by an elastic element mounted on said frame, said pendulum arm includes a socket having a socket longitudinal axis, said socket rotatably embraces said driving shaft, and is capable of swinging about the driving shaft, wherein said internal pin longitudinal rotational axis, said driving shaft longitudinal rotational axis, and said socket longitudinal axis essentially coincide; and
a balancing lever rotatably mounted on and capable of swinging about an axle of swinging joined with the pendulum arm.

2. The levered centerpoint suspension according to claim 1, wherein said at least one caterpillar track includes:
an upper branch; and
at least one upper support rolling wheel supporting said upper branch and mounted on said balancing lever in a region located upwards and forwards from said axle of swinging.

3. The levered centerpoint suspension according to claim 1, further comprising a means for adjusting a position of said axle of swinging in relation to a position of said pendulum arm.

4-8. (canceled)

9. The levered centerpoint suspension according to claim 1, wherein
said pendulum arm has a fork-like shape defining two fork blades;
said balancing lever has an H-like shape defining two longitudinal girders interconnected by means of a crossbar; said balancing lever is located partially between the fork blades.

10. The levered centerpoint suspension according to claim 9, wherein said axle for swinging extends within said crossbar, whereas the crossbar serves as a socket for swinging said balancing lever.

11. The levered centerpoint suspension according to claim 9, wherein said at least one caterpillar track includes:
an upper branch; and
at least one upper support rolling wheel supporting said upper branch and mounted on said balancing lever in a region located upwards and forwards from said axle of swinging.

12. The levered centerpoint suspension according to claim 9, further comprising a means for adjusting a position of said axle of swinging in relation to a position of said pendulum arm.

13. The levered centerpoint suspension according to claim 9, wherein said caterpillar drive further including:
a number of rear track guiding wheels connected by a rear shaft;
said levered centerpoint suspension further comprising:
a pair of bracket-earrings mounted on the rear ends of said girders, said bracket-earrings have an axis of swinging substantially perpendicular to the longitudinal plane of the vehicle, said bracket-earrings are interconnected through said rear shaft; and
a means for limiting the rotation and the backward displacement of said rear track guiding wheels; said means for limiting joins said girders with said bracket-earrings;
wherein,
during the swinging, said rear shaft is capable of movement in the longitudinal direction with said rear track guiding wheels.
